(19) United States
(12) Patent Application Publication
(10) Pub. No.: US 2023/0329961 A1
(43) Pub. Date: Oct. 19, 2023

(54) Scalp massager

(71) Applicant: Lollipop Technology (Hangzhou) Co., Ltd., Hangzhou (CN)

(72) Inventors: Hangke Jiang, Hangzhou (CN); Nuo Xu, Hangzhou (CN)

(21) Appl. No.: 17/659,484

(22) Filed: Apr. 16, 2022

(51) Int. Cl. A61H 15/00; A61H 7/00

(52) U.S. Cl. CPC A61H 15/0092; A61H 7/003; A61H 7/001; A61H 2015/0057; A61H 2015/0042; A61H 2205/021; A61H 2201/0153; A61H 2201/1604

(57) ABSTRACT

The present invention relates to a multifunctional scalp massager, has a handle and a plurality of elastic massage claws arranged along the circumference of the handle, each elastic massage claw is formed in an arc shape, and a massage portion is arranged at the end of each elastic massage claw away from the handle; the elastic massage claws have a plurality of elastic massage claws with different arc lengths and radians, and the number of the elastic massage claws is at least 20, so that when the elastic massage claws are clamped on the human body, the claws of different lengths can touch different parts of the human body. The present invention has the advantages of good massage effect, capability of massaging different parts of the head and more plentiful functions.

### BACKGROUND OF THE PRESENT INVENTION

### Field of Invention

The present invention relates to the technical field of massage device, in particular to a multifunctional scalp massager.

### DESCRIPTION OF RELATED ARTS

At present, most of the scalp massagers on the market can only massage the scalp, so their function is relatively simple; and they have only 16 to 18 massage claws, resulting in weak massage force and poor massage experience. For example, a massager disclosed in Chinese patent CN200966729Y includes elastic rods, the elastic rods are metal wires or steel wires or stainless steel wires or copper wires, the elastic rods have contacts, and the 6 or 8 or 12 or 16 or 18 elastic rods are evenly distributed and fixed on a handle. The handle of the massager is held, the contacts of the elastic rods receive the force of the hand and the elastic force of the elastic rods, and the forces are applied to the contact part to achieve a good massage effect.

Therefore, there is an urgent need for a multifunctional scalp massager that has more plentiful functions, can massage more parts of the head and has a good massage effect.

### SUMMARY OF THE PRESENT INVENTION

The objective of the present invention is to provide a multifunctional scalp massager in response to the above problems of the prior art.

In order to achieve the above objective of the present invention, the present invention adopts the following technical solution: a multifunctional scalp massager includes a handle and a plurality of elastic massage claws arranged along the circumference of the handle, each elastic massage claw is formed in an arc shape, and a massage portion is arranged at the end of each elastic massage claw away from the handle;

The elastic massage claws include a plurality of elastic massage claws with different arc lengths and radians, and the number of the elastic massage claws is at least 20, so that when the elastic massage claws are clamped on the human body, the claws of different lengths can touch different parts of the human body.

Working principle and beneficial effects are: 1. Compared with the prior art, the present application first uses more elastic massage claws, and is composed of a plurality of elastic massage claws with different arc lengths and radians, so that when the elastic massage claws are clamped on the human body, the elastic massage claws of different lengths can touch different parts of the human body, and thus the massage portions can not only massage the scalp, but also massage the temples, neck and other parts; the elastic massage claws can also be used on other parts of the human body, such as knees and arms, so that the massager can touch and massage more parts, with a better massage effect and more plentiful functions.

2. The present application uses the elastic massage claws with different arc lengths and radians. When the head is massaged, the longer elastic massage claws can massage the temples, while the other shorter claws can avoid the parts such as human eyes and massage the forehead, thereby avoiding hurt to the human body and achieving a better massage effect.

Further, two elastic massage claws arranged symmetrically constitute a pair and form a claw assembly, a connecting portion is arranged in the center of the claw assembly, and the connecting portion can be inserted into the handle to be connected and fixed with the handle.

This arrangement can reduce the structural complexity of the massager and especially simplify the structure of the elastic massage claws. The elastic massage claws can be conveniently fixed on the handle by means of the connecting portion, for example, can be fixed by rivets, screws or buckles, so that the massager is simple in structure and convenient to operate.

Further, two elastic massage claws with the same arc length and radian constitute a pair and form a claw assembly, so as to form multiple claw assemblies with different sizes.

This arrangement can reduce the difficulty of arranging the elastic massage claws, and facilitates classification and assembly.

Further, the number of elastic massage claws is 20 or 22 or 24 or 26 or 28 or 30.

With such arrangement, the numbers of elastic massage claws are several preferred solutions obtained by our company after many tests, which can provide a better massage effect while ensuring a lower cost.

Further, each massage portion is formed by a dispensing process. With such arrangement, when the massager touches the scalp, it feels softer and smoother.

Further, the claw assemblies are divided into long claw assemblies and short claw assemblies in equal numbers. Thus, the number of elastic massage claws is 20 or 24 or 28.

Further, the distance between the outermost end of each elastic massage claw of the long claw assembly and the handle is 150 mm to 170 mm, and the distance between the outermost end of each elastic massage claw of the short claw assembly and the handle is 120 mm to 140 mm.

On the basis of the size data obtained by many experiments, when the massager is pressed to the lowest position, massage contacts just reach the ears. The distances not only protect the ears from being touched by the massager, but also ensure that most parts of the head are massaged.

Further, the center distance between the massage portions on the two elastic massage claws of the long claw assembly is 95 mm to 105 mm, and the center distance between the massage portions on the two elastic massage claws of the short claw assembly is 111 mm to 121 mm.

With such arrangement, when the two long claws touch the scalp and move down, the two short claws can slide on the scalp smoothly and naturally.

Further, each massage portion is a ball assembly, the ball assembly includes a ball seat connected with the elastic massage claw and a massage ball movably connected with the ball seat, and the massage ball is at least partially exposed outside the ball seat, so that the massage ball can directly touch the human body.

With such arrangement, compared with the solution of the other dispensing process, the movable massage balls can slide on the skin more smoothly, which can reduce the friction force. Meanwhile, the massage balls made of stainless steel can be used to provide a better massage effect.

Further, the distance a that the massage ball protrudes from the ball seat is greater than the distance b between the center of the massage ball and the outermost end of the ball seat, the sum of the distance a and the distance b is equal to the radius c of the massage ball, and the distance b is less than or equal to ⅓ of the radius c.

With such arrangement, the massage ball can naturally head into the ball seat.

### BRIEF DESCRIPTION OF THE DRAWINGS

FIG. 1 is a schematic structural illustration of the present invention;

FIG. 2 is a schematic illustration of an internal structure of the present invention;

FIG. 3 is a schematic illustration of an embodiment of elastic massage claws;

FIG. 4 is a schematic illustration of one embodiment of a long claw assembly;

FIG. 5 is a schematic illustration of one embodiment of a short claw assembly;

FIG. 6 is a schematic structural illustration of a ball assembly;

FIG. 7 is a schematic illustration of one embodiment of the ball assembly.

In the figures: 1, handle; 2, elastic massage claw; 3, massage portion; 4, claw assembly; 41, connecting portion; 42, long claw assembly; 43, short claw assembly; 5, ball assembly; 51, massage ball; 52, ball seat.

### DETAILED DESCRIPTION OF THE PREFERRED EMBODIMENT

A clear and complete description will be made to the technical solutions in the embodiments of the present invention below with reference to the accompanying drawings in the embodiments of the present invention. Apparently, the embodiments described are only part of the embodiments of the present invention, not all of them. Based on the embodiments of the present invention, all other embodiments obtained by those of ordinary skill in the art shall fall into the protection scope of the present invention.

Those skilled in the art should understand that, in the disclosure of the present invention, the orientations or positional relationships indicated by the terms “longitudinal”, “lateral”, “upper”, “lower”, “front”, “rear”, “left”, “right”, “vertical”, “horizontal”, “top”, “bottom”, “inner”, “outer”, etc. are based on the orientations or positional relationships shown in the accompanying drawings, and are intended to facilitate the description of the present invention and simplify the description only, rather than indicating or implying that the device or element referred to must have a particular orientation or be constructed and operated in a particular orientation, and therefore, these terms cannot be interpreted as limiting the present invention.

### Embodiment 1

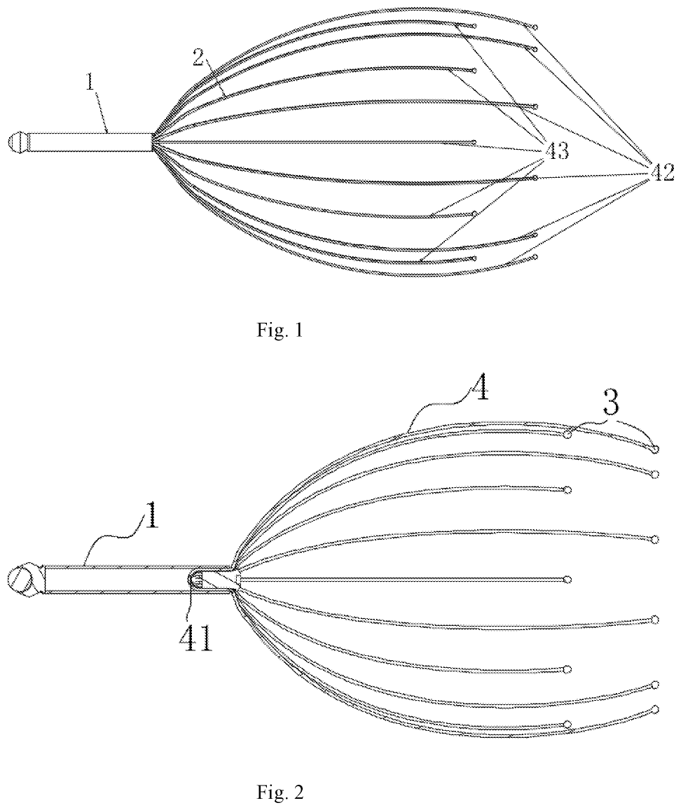

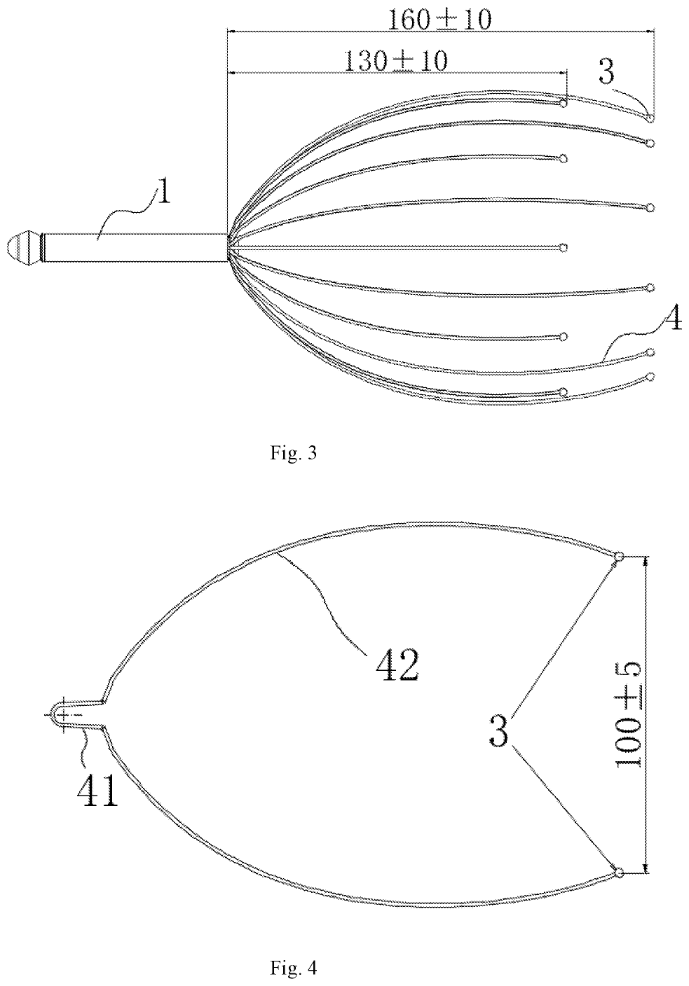

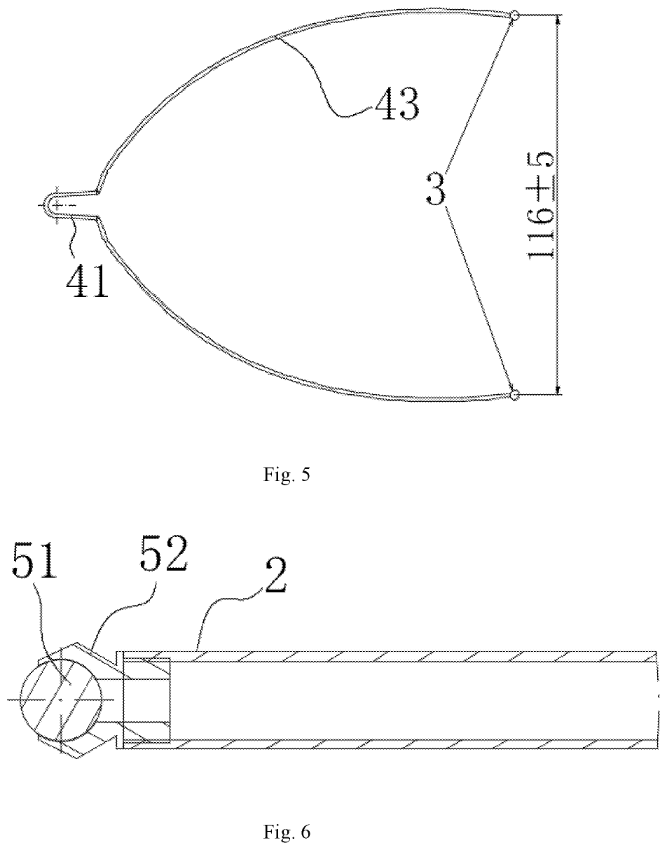

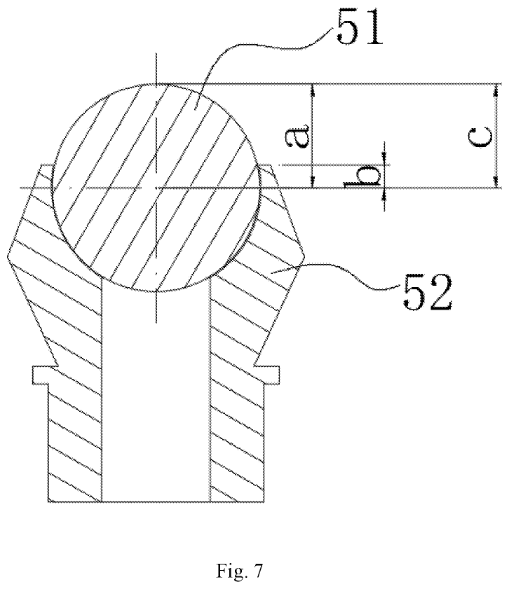

As shown in FIGS. 1-3, a multifunctional scalp massager includes a handle 1 with a hollow cylindrical structure and a plurality of elastic massage claws 2 arranged along the circumference of the handle 1. Each elastic massage claw 2 is formed in an arc shape, and a massage portion 3 is arranged at the end of each elastic massage claw 2 away from the handle 1.

Specifically, the elastic massage claws 2 include a plurality of elastic massage claws 2 with different arc lengths and radians, all of which are elastic pieces that can either contract inward or expand outward, and the number of the elastic massage claws 2 is at least 20, so that when the elastic massage claws 2 are clamped on the human body, the claws of different lengths can touch different parts of the human body.

In this embodiment, two elastic massage claws 2 with the same arc length and radian constitute a pair and form a claw assembly 4, so as to form multiple claw assemblies 4 with different sizes. Therefore, the elastic massage claws 2 form multiple claw assemblies 4 with different arc lengths and radians, which can simultaneously touch multiple parts of the human body.

Preferably, a connecting portion 41 is arranged in the center of the claw assembly 4, and the connecting portion 41 can be inserted into the handle 1 to be connected and fixed with the handle 1, which can reduce the structural complexity of the massager and especially simplify the structure of the elastic massage claws 2. The elastic massage claws 2 can be conveniently fixed on the handle 1 by means of the connecting portion 41, for example, can be fixed by rivets, screws or buckles, so that the massager is simple in structure and convenient to operate.

Preferably, the number of elastic massage claws 2 is 20 or 22 or 24 or 26 or 28 or 30, that is, the number of claw assemblies 4 is 10 or 11 or 12 or 13 or 14 or 15, the diameter of the handle 1 also increases with the increase of the claw assemblies 4, and more preferably, the claw assemblies 4 are divided into long claw assemblies 42 and short claw assemblies in equal numbers. Thus, when the head is massaged, the longer elastic massage claws 2 can massage the temples, while the other shorter claws can avoid the parts such as human eyes and massage the forehead, thereby avoiding hurt to the human body and achieving a better massage effect.

Preferably, the distance between the outermost end of each elastic massage claw 2 of the long claw assembly 42 and the handle 1 is 150 mm to 170 mm, the distance between the outermost end of each elastic massage claw 2 of the short claw assembly 43 and the handle 1 is 120 mm to 140 mm, the center distance between the massage portions 3 on the two elastic massage claws 2 of the long claw assembly 42 is 95 mm to 105 mm, and the center distance between the massage portions 3 on the two elastic massage claws 2 of the short claw assembly 43 is 111 mm to 121 mm.

### Embodiment 2

In this embodiment, each massage portion 3 is formed by a dispensing process, such as being made of silicone or latex material. When the massager touches the scalp, it feels softer and smoother.

### Embodiment 3

In this embodiment, each massage portion 3 is a ball assembly 5, the ball assembly 5 includes a ball seat 52 connected with the elastic massage claw 2 and a massage ball 51 movably connected with the ball seat 52, and the massage ball 51 is at least partially exposed outside the ball seat 52, so that the massage ball 51 can directly touch the human body. The distance a that the massage ball 51 protrudes from the ball seat 52 is greater than the distance b between the center of the massage ball 51 and the outermost end of the ball seat 52, the sum of the distance a and the distance b is equal to the radius c of the massage ball 51, the distance b is less than or equal to ⅓ of the radius c, and the relationship between the three is a>b and b≤⅓c. Compared with the solution of the other dispensing process, the movable massage balls 51 can slide on the skin more smoothly, which can reduce the friction force. Meanwhile, the massage balls 51 made of stainless steel can be used to provide a better massage effect.

### Embodiment 4

This embodiment combines Embodiment 2 and Embodiment 3. The ball assembly 5 of Embodiment 3 can be used on the long claw assembly 42, and the dispensing process of Embodiment 2 can be used on the short claw assembly 43. Alternatively, the dispensing process of Embodiment 2 can be used on the long claw assembly 42, and the ball assembly 5 of Embodiment 3 can be used on the short claw assembly 43.

The unspecified part of the present invention is the prior art, and therefore is not described in detail in the present invention.

It can be understood that the term “a” should be understood as “at least one” or “one or more”, that is, in one embodiment, the number of an element may be one, and in another embodiment, the number of the element may be more than one, so the term “one” cannot be understood as a restriction on the number.

Although the terms such as handle 1, elastic massage claw 2, massage portion 3, claw assembly 4, connecting portion 41, long claw assembly 42, short claw assembly 43, ball assembly 5, massage ball 51, and ball seat 52 are used more herein, the possibility of using other terms is not excluded. These terms are used only to describe and explain the essence of the present invention more conveniently, and interpreting them as any additional limitation is contrary to the spirit of the present invention.

The present invention is not limited to the above best embodiments. Any person can derive other products in various forms under the enlightenment of the present invention. However, regardless of any change in shape or structure, all other technical solutions that are the same or similar to the technical solutions of the present application shall fall within the protection scope of the present invention.

1. A multifunctional scalp massager, comprising a handle and a plurality of elastic massage claws arranged along the circumference of the handle, wherein each elastic massage claw is formed in an arc shape, and a massage portion is arranged at the end of each elastic massage claw away from the handle;
the elastic massage claws comprise a plurality of elastic massage claws with different arc lengths and radians, and the number of the elastic massage claws is at least 20, so that when the elastic massage claws are clamped on the human body, the claws of different lengths can touch different parts of the human body.

2. The multifunctional scalp massager according to claim 1, wherein two elastic massage claws arranged symmetrically constitute a pair and form a claw assembly, a connecting portion is arranged in the center of the claw assembly, and the connecting portion can be inserted into the handle to be connected and fixed with the handle.

3. The multifunctional scalp massager according to claim 2, wherein two elastic massage claws with the same arc length and radian constitute a pair and form a claw assembly, so as to form multiple claw assemblies with different sizes.

4. The multifunctional scalp massager according to claim 3, wherein the number of elastic massage claws is 20 or 22 or 24 or 26 or 28 or 30.

5. The multifunctional scalp massager according to claim 3, wherein the claw assemblies are divided into long claw assemblies and short claw assemblies in equal numbers.

6. The multifunctional scalp massager according to claim 5, wherein the distance between the outermost end of each elastic massage claw of the long claw assembly and the handle is 150 mm to 170 mm, and the distance between the outermost end of each elastic massage claw of the short claw assembly and the handle is 120 mm to 140 mm.

7. The multifunctional scalp massager according to claim 6, wherein the center distance between the massage portions on the two elastic massage claws of the long claw assembly is 95 mm to 105 mm, and the center distance between the massage portions on the two elastic massage claws of the short claw assembly is 111 mm to 121 mm.

8. The multifunctional scalp massager according to claim 1, wherein each massage portion is formed by a dispensing process.

9. The multifunctional scalp massager according to claim 1, wherein each massage portion is a ball assembly, the ball assembly comprises a ball seat connected with the elastic massage claw and a massage ball movably connected with the ball seat, and the massage ball is at least partially exposed outside the ball seat, so that the massage ball can directly touch the human body.

10. The multifunctional scalp massager according to claim 9, wherein the distance a that the massage ball protrudes from the ball seat is greater than the distance b between the center of the massage ball and the outermost end of the ball seat, the sum of the distance a and the distance b is equal to the radius c of the massage ball, and the distance b is less than or equal to ⅓ of the radius c.
